(19) United States
(12) Patent Application Publication
(10) Pub. No.: US 2024/0229974 A1
(43) Pub. Date: Jul. 11, 2024

(54) APPARATUS AND METHOD FOR COUPLING PIPE SECTIONS IN A BODY OF WATER AND JUNCTION SYSTEM FOR JOINING PIPE SECTIONS IN THE BODY OF WATER

(71) Applicant: SAIPEM S.P.A., Milano (IT)

(72) Inventors: Enrico Girello, Milano (IT); Diego Bruno, Milano (IT); Diego Lazzarin, Milano (IT)

(21) Appl. No.: 18/558,653

(22) PCT Filed: May 5, 2022
(86) PCT No.: PCT/IB2022/054154

§ 371 Date: Nov. 2, 2023

(30) Foreign Application Priority Data
May 7, 2021 (IT) 102021000011795

(51) Int. Cl. F16L 1/26

(52) U.S. Cl. CPC F16L 1/26

(57) ABSTRACT

An apparatus for coupling pipe sections into a body of water has a frame comprising an elongated portion, which extends along a longitudinal axis and is configured to be arranged within a first pipe section; an alignment device, which is supported by the elongated portion of the frame and is configured to be at least partially inserted inside a second pipe section so as to align the first pipe section with the second pipe section; and a locking device, which is supported by the elongated portion of the frame and is configured to lock the position of the first pipe section with respect to the second pipe section when the first pipe section is aligned with the second pipe section.

### PRIORITY CLAIM

This application is a national stage application of PCT/IB2022/054154, filed on May 5, 2022, which claims the benefit of and priority to Italian Patent Application No. 102021000011795, filed on May 7, 2021, the entire contents of which are each incorporated by reference herein.

### TECHNICAL FIELD

The present disclosure relates to an apparatus and a method for coupling pipe sections in a body of water. The present disclosure further relates to a junction system to join pipe sections in the body of water.

In particular, the present disclosure relates to an apparatus for coupling pipe sections, so as to remotely reconfigure underwater structures originally designed for connections performed by divers.

### BACKGROUND

In the oil and gas sector, recent technological developments in underwater infrastructures suitable for operating at relatively high depths and the relative strong interest of oil companies have facilitated the spread of underwater facilities for the extraction, production or transport of hydrocarbons. Such underwater facilities can be located in relatively shallow waters or relatively very deep waters and generally comprise one or more pipelines for the transport of hydrocarbons or fluids employed in hydrocarbon extraction operations.

In general, for the purposes of the present disclosure the term “pipeline” means a pipeline, which, in use, lies on the bed of a body of water or in the vicinity of the bed of the body of water and is intended to convey gases and/or liquids, in particular hydrocarbons. A pipeline of the type identified above can extend for hundreds of kilometres and is composed of pipe sections joined to each other.

In the steps of installing and maintaining underwater pipelines, there is currently a need to join two adjacent pipeline portions to each other to ensure the continuity of the pipeline itself.

In the past, this junction operation was carried out by divers, who stayed for long periods in chambers of saturation plants immersed in an air consisting of oxygen and helium at a pressure equal to the pressure at the bed of the body of water. These chambers were transported by ships and were connected to diving bells, which transferred the divers from the surface of the body of water to the bed of the body of water and vice versa to allow the divers to carry out the operations of joining the two portions of pipeline.

The use of divers to carry out such junction operations was relatively extremely time and cost consuming and put the health of the divers at risk. Further drawbacks were related to the lack of repeatability of the junction operations carried out by divers, and in general to the relatively poor reliability and precision of the junction of the two pipelines.

In recent decades, the installation of underwater facilities and underwater pipelines deeper and deeper in the body of water has led, as an alternative to the use of divers, to the use of unmanned underwater vehicles of the Remotely Operated Vehicle (“ROV”) type or the Autonomous Underwater Vehicle (“AUV”) type and of junction tools operatively connected to these vehicles.

According to certain of the prior art, in order to allow the junction operations to be carried out through the use of unmanned underwater vehicles and the respective junction tools, it is necessary that the end of each portion of the pipeline to be joined is provided with a respective flange designed to be operated by said junction tools.

However, underwater pipelines installed in the past are still configured to be operated by divers. Typically, the end portions of said pipelines are provided with flanges designed to allow junction operations by divers and, consequently, are not suitable to be operated by the currently known junction tools.

Accordingly, in order to reconfigure the pipelines installed in the past, each pipeline to be reconfigured is joined to a pipe section provided at one end of a flange designed to be operated by unmanned underwater vehicles and the respective junction tools.

GB Patent Document No. 2,323,907 describes an apparatus for connecting underwater pipelines comprising respective end portions provided with flanges designed to be operated by divers.

However, the operations carried out by the apparatus of GB Patent Document No. 2,323,907 require relatively considerable spaces and dimensions around the flanges of the pipelines to be connected.

In addition, the apparatus of GB Patent Document No. 2,323,907 requires a bearing base and is configured to operate with wide tolerances and join the flanges of the pipelines through a deformation of the flanges themselves.

### SUMMARY

An object of the present disclosure is to provide an apparatus for coupling pipe sections in a body of water that is free of certain of the drawbacks of certain of the prior art and that is particularly versatile.

In particular, it is an object of the present disclosure to provide an apparatus for coupling pipe sections in a body of water in a relatively simple and economical manner.

According to the present disclosure, an apparatus for coupling pipe sections into a body of water is made, the apparatus comprising: a frame connectable to an unmanned underwater vehicle and comprising an elongated portion, which extends along a longitudinal axis and is configured to be arranged at least partially within a first pipe section (so that, in certain instances, the first pipe section is aligned with respect to the longitudinal axis); an alignment device, which is supported by the elongated portion of the frame and is configured to be at least partially inserted inside a second pipe section so as to align the first pipe section with the second pipe section; and a locking device, which is supported by the elongated portion of the frame and is configured to lock the position of the first pipe section with respect to the second pipe section when the first pipe section is aligned with the second pipe section.

It should be appreciated that in accordance with the present disclosure, through an underwater vehicle it is possible to arrange and keep aligned in a body of water a first and a second pipe section in a relatively simple and economical manner to subsequently enable the junction of the first and the second pipe section. In this way, it is possible to couple the first and the second pipe section even in relatively narrow spaces and without the need to use a bearing base.

In certain embodiments, the apparatus comprises a handling device, which is coupled to the elongated portion of the frame and is configured to move the alignment device and the locking device in a direction substantially parallel to the longitudinal axis. In this way, it is possible to insert the alignment device inside the second pipe section and arrange the locking device in a specific locking position and at the same time to relatively precisely adjust the position of the first pipe section with respect to the second pipe section.

In certain embodiments, the handling device comprises an actuator, such as a hydraulic type, so as to actuate the handling of the alignment device and the locking device in a relatively simple manner.

In certain embodiments, the alignment device and the locking device are aligned along the longitudinal axis, so as to be inserted inside the first pipe section or the second pipe section during the coupling of the first pipe section with the second pipe section.

In certain embodiments, the alignment device comprises at least one expansible element, such as made of a polymeric material, which is configured to selectively expand so as to contact an inner surface of the second pipe section when the alignment device is inserted within the second pipe section. In this way, it is possible to align the elongated portion of the frame with the second pipe section. Accordingly, the first pipe section, which is arranged around the elongated portion of the frame, is aligned with the second pipe section.

In certain embodiments, the locking device comprises a plurality of movable gripping units, which are selectively actuatable to contact a wall of the second pipe section to lock the position of the elongated portion of the frame with respect to the second pipe section. In this way, it is possible to lock the first pipe section with respect to the second pipe section in a specific position to enable the subsequent junction of the two facing ends of the first and the second pipe section.

In certain embodiments, the apparatus comprises a centering device, which is arranged at one end of the elongated portion of the frame and is shaped so as to facilitate the insertion of the alignment device within the second pipe section. In this way, it is possible to insert the elongated portion of the frame inside the second pipe section even if the first pipe section is initially misaligned with respect to the second pipe section.

In certain embodiments, the apparatus comprises a retaining device, which is carried by the frame and comprises a plurality of movable arms configured to selectively retain/release the first pipe section. In this way, it is possible to retain the first pipe section around the elongated portion of the frame, during the transport of the first pipe section from the surface of the body of water to the second pipe section, and release the first pipe section after the first pipe section has been joined to the second pipe section.

In certain embodiments, the apparatus comprises at least one floating module coupled to the frame, so as to regulate the floating of the apparatus in the body of water.

A further object of the present disclosure is to provide a junction system for joining pipe sections in a body of water which is free from the drawbacks of the prior art.

According to the present disclosure, a junction system for joining pipe sections into a body of water is made, the system comprising: the above-described apparatus and a junction device, which is carried by the apparatus and is configured to join a first flange of the first pipe section to a second flange of the second pipe section facing the first flange when the first pipe section is aligned and locked with respect to the second pipe section. In accordance with the junction system, it is possible to join in a body of water a first and a second pipe section in a relatively simple and economical manner, avoiding the use of divers to carry out the junction operations.

In certain embodiments, the junction device comprises a plurality of bolted junctions, which extend from opposite bands with respect to the first and the second flange and are selectively lockable to clamp the first and the second flange together. In this way, it is possible to enable the automated junction of ends of pipe sections provided with connection flanges suitable to be operated by divers.

In certain embodiments, the system comprises an unmanned underwater vehicle, which is configured to be operatively connected to the apparatus so as to control the position and the actuation of the apparatus in the body of water. In this way, it is possible to transport the system in the body of water and provide the system with a power supply to carry out the coupling and junction operations of the first and the second pipe section.

A further object of the present disclosure is to provide a method for coupling pipe sections in a body of water which is free from certain of the drawbacks of certain of the prior art.

According to the present disclosure, a method for coupling pipe sections into a body of water by an apparatus comprising an alignment device, a locking device, and a frame provided with an elongated portion, which extends along a longitudinal axis is performed; the method including arranging the elongated portion of the frame at least partially within a first pipe section (such that the first pipe section is aligned with respect to the longitudinal axis); inserting the alignment device at least partially inside a second pipe section so that the first pipe section is aligned with the second pipe section; and locking the position of the first pipe section with respect to the second pipe section by the locking device when the first pipe section is aligned with the second pipe section. In accordance with such a method, it is possible to couple in a body of water a first and a second pipe section in an automated manner to enable the subsequent junction of the two facing ends of the first and the second pipe section without the aid of divers.

### BRIEF DESCRIPTION OF THE DRAWINGS

Further characteristics and advantages of the present disclosure will become clear from the following description of a non-limiting example of implementation, with reference to the appended Figures, wherein:

FIG. 1 is a side elevation view, with schematic parts and parts removed for clarity, of an underwater infrastructure and a junction system for joining pipe sections in a body of water made in accordance with the present disclosure;

FIG. 2 is a side elevation view, with schematic parts and parts removed for clarity, of a detail of the junction system of FIG. 1;

FIG. 3 is a side view, with parts removed for clarity, of a junction device of the junction system of FIG. 1 coupled to a first pipe section;

FIG. 4 is a side elevation view, with parts removed for clarity, of an apparatus for coupling pipe sections of the junction system of FIG. 1;

FIG. 5 is a sectional view, with parts removed for clarity, along the cutting lines V-V of the apparatus of FIG. 4;

FIG. 6 is a section view, with parts removed for clarity, of a detail of the apparatus of FIG. 4; and

FIGS. 7 and 8 are side elevation views, with schematic parts and parts removed for clarity, of an underwater infrastructure and the junction system of FIG. 1 in further operational configurations.

### DETAILED DESCRIPTION

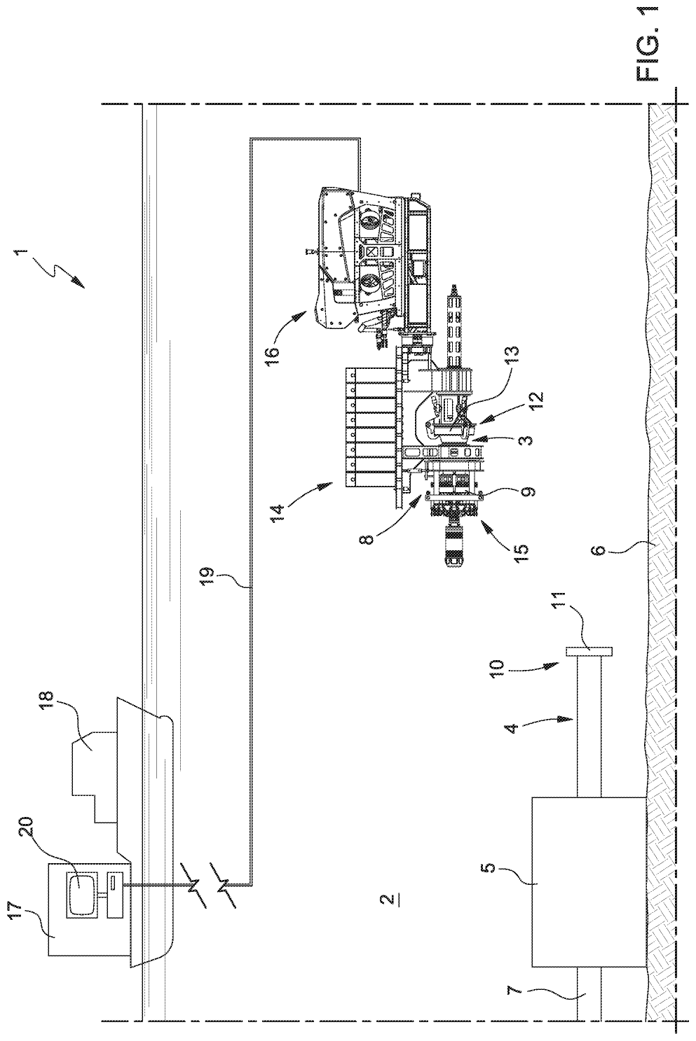

With reference to FIG. 1, reference numeral 1 indicates, as a whole, a junction system configured to join pipe sections in a body of water 2. In more detail, the junction system 1 is configured to join a pipe section 3 with a pipe section 4, which is part of an underwater infrastructure 5 (FIG. 1).

In the case described and illustrated herein, but not limited to the present disclosure, the underwater infrastructure 5 is arranged on a bed 6 of the body of water 2 and the pipe section 4 constitutes an end portion of a pipeline 7 intended to convey gases and/or liquids, in particular hydrocarbons.

In particular, the pipe section 3 comprises an end 8 provided with a flange 9 and the pipe section 4 comprises a free end 10 provided with a flange 11. The flange 9 and the flange 11 are configured to be coupled to each other by fasteners (not shown) so as to join the pipe section 3 to the pipe section 4. In more detail, the flange 9 and the flange 11 have respective through openings (not shown) through which, in use, said fasteners are inserted so as to secure the flange 9 to the flange 11.

In addition, the pipe section 3 comprises an end 12, which is opposite to the end 8 and is provided with a flange 13. In the embodiment described and shown herein, but not limited to the present disclosure, the flange 13 is free of through openings and is configured to be coupled to a flange of a further pipe section (not shown) by an automatic equipment (not shown) controlled by an unmanned underwater vehicle.

It is understood that the junction system 1 made in accordance with the present disclosure is configured to join both the pipe sections 3 and 4, which comprise respective flanges 9, 11 and 13 of the type identified above, and further pipe sections, which are free of respective flanges or are provided with flanges of a different type from the flanges 9, 11 and 13.

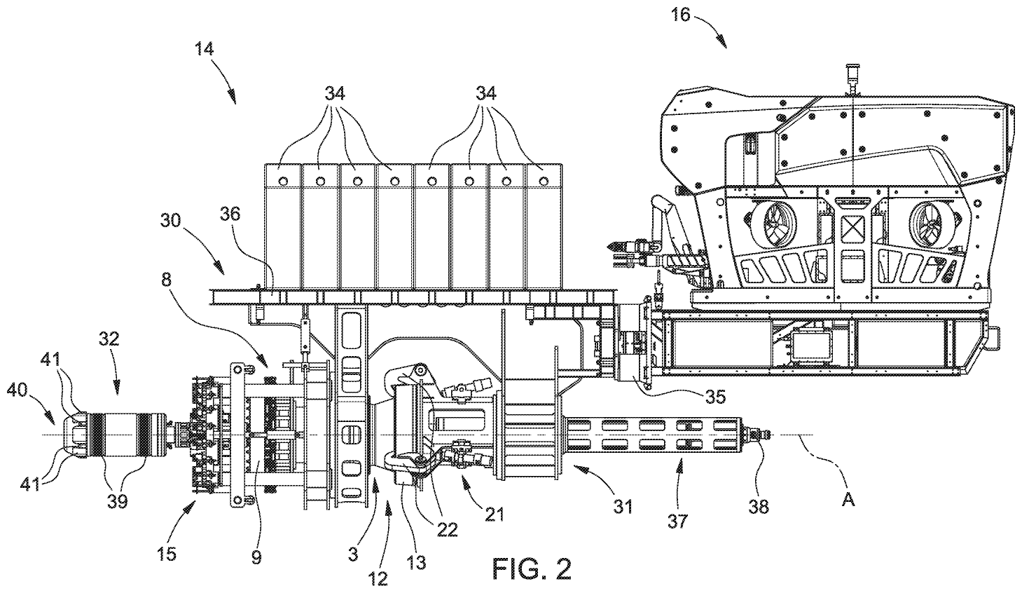

With reference to FIGS. 1 and 2, the junction system 1 comprises an apparatus 14 configured to couple pipe sections in the body of water 2; and a junction device 15, which is carried by the apparatus 14 and is configured to join the flange 9 of the pipe section 3 to the flange 11 of the pipe section 4 facing the flange 9 when the pipe section 3 is aligned and locked with respect to the pipe section 4.

In addition, the junction system 1 comprises an unmanned underwater vehicle 16, which is configured to be operatively connected to the apparatus 14 so as to control the position and the actuation of the apparatus 14 in the body of water 2.

In the case described and illustrated herein, the underwater vehicle 16 is of the ROV type. Within the scope of the present description, the term “ROV” means a Remotely Operated Vehicle.

With reference to FIG. 1, the junction system 1 comprises a surface station 17, which, in certain embodiments, is arranged on a support boat 18 and is connected to the underwater vehicle 16 by an umbilical cable 19, and a control unit 20 arranged in the surface station 17 to control the junction system 1.

The umbilical cable 19 is configured to supply electrical power to the underwater vehicle 16 and exchange signals with the underwater vehicle 16, which in turn exchanges signals with the apparatus 14 and the junction device 15.

In accordance with a variant of the present disclosure (not shown), the underwater vehicle 16 is of the AUV type. Within the scope of the present description, the term “AUV” means an Autonomous Underwater Vehicle.

In accordance with a further variant of the present disclosure (not shown), the junction system 1 comprises, as an alternative to the underwater vehicle 16, a lifting device, which is arranged on the surface station 17 and is configured to move the apparatus 14 and the junction device 15 in the body of water 2.

With reference to FIG. 2, the apparatus 14 comprises a retaining device 21, which is carried by the apparatus 14 and comprises a plurality of movable arms 22 configured to selectively retain/release the pipe section 3.

In particular, each movable arm 22 is hydraulically actuated and is configured to retain the pipe section 3 until the pipe section 3 is joined to the pipe section 4 and to release the pipe section 3 once the pipe section 3 is joined to the pipe section 4. In more detail, each movable arm 22 is movable between a closed position, in which the movable arm 22 is gripped by the flange 13 of the end 12 of the pipe section 3, and an open position, in which the movable arm 22 is at a distance from the further flange 13 of the pipe section 3.

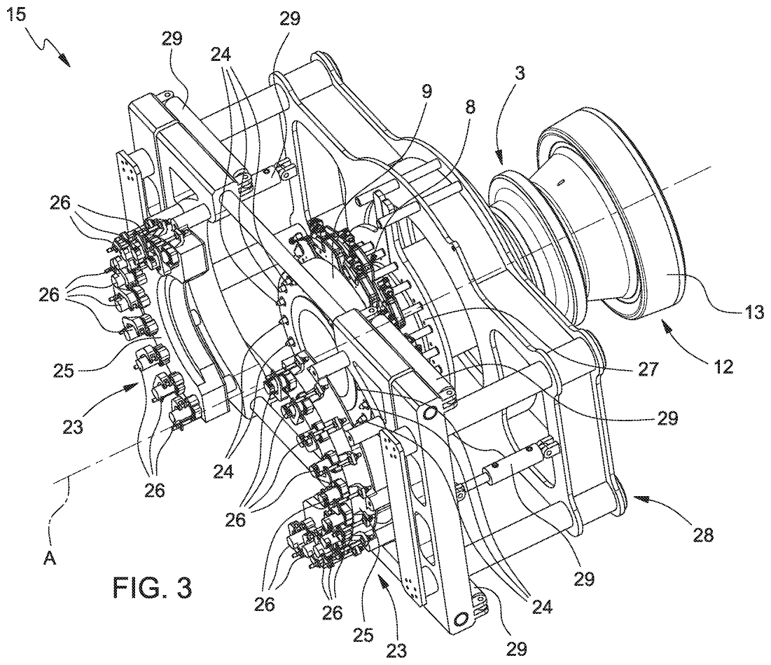

With reference to FIG. 3, the junction device 15 comprises a plurality of bolted junctions 23, which are configured to extend from opposite bands with respect to the flange 9 and the flange 11 (FIG. 1) and are selectively lockable so as to clamp the flange 9 and the flange 11 together.

In accordance with an embodiment, but not limited to the present disclosure, each bolted junction 23 comprises a respective screw 24 and a respective nut (not shown).

In particular, the junction device 15 comprises two movable arms 25 configured to be closed around the free end 10 of the pipe section 4 at the flange 11 (FIG. 1). In certain embodiments, each movable arm 25 carries said nuts of the bolted junctions 23 and comprises a screwing device 26 for each bolted junction 23.

In addition, the junction device 15 comprises a plate 27 configured to be arranged around the pipe section 3 and to carry the screws 24, which in use are at least partially inserted into respective through openings of the flange 9; and an adjustment mechanism 28, which comprises a plurality of actuators 29 configured to adjust the relative position of the movable arms 25 and the plate 27 with respect to the flanges 9 and 11.

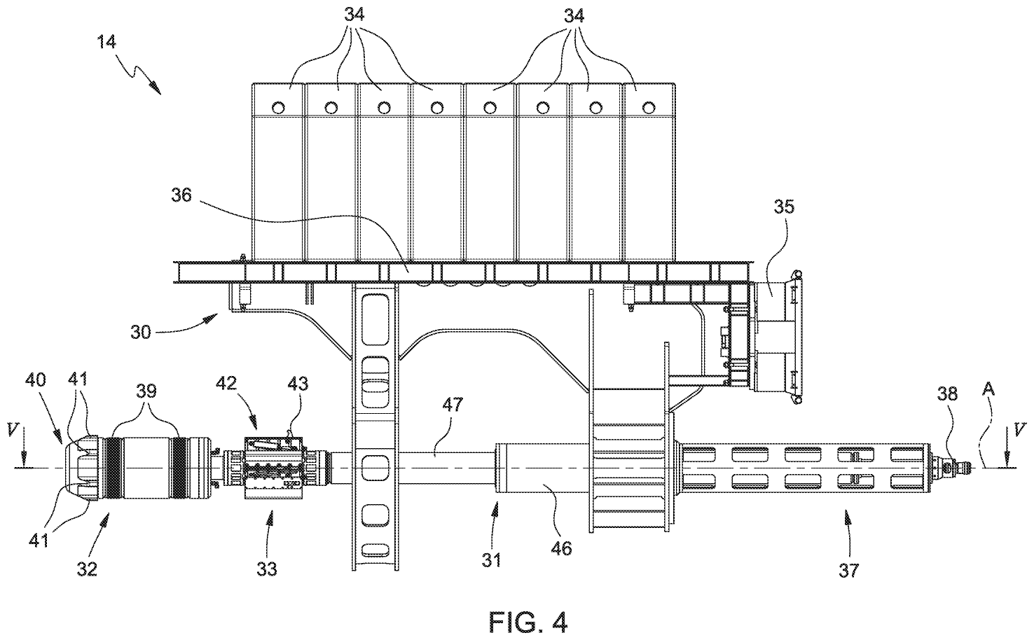

With reference to FIG. 4, the apparatus 14 comprises a frame 30 connectable to the unmanned underwater vehicle 16 (FIGS. 1 and 2) and comprising an elongated portion 31, which extends along a longitudinal axis A and is configured to be arranged at least partially inside the pipe section 3, in certain embodiments so that the pipe section 3 is aligned with respect to the longitudinal axis A; an alignment device 32, which is supported by the elongated portion 31 of the frame 30 and is configured to be at least partially inserted within the pipe section 4 so as to align the pipe section 3 with the pipe section 4; and a locking device 33, which is supported by the elongated portion 31 of the frame 30 and is configured to lock the position of the pipe section 3 with respect to the pipe section 4 when the pipe section 3 is aligned with the pipe section 4.

In particular, the alignment device 32 and the locking device 33 are aligned along the longitudinal axis A.

In addition, the apparatus 14 comprises at least one floating module 34 coupled to the frame 30. In the case described and illustrated herein, but not limited to the present disclosure, the apparatus 14 comprises eight floating modules 34 arranged side by side.

In particular, the frame 30 comprises a coupling portion 35, which is configured to couple to the underwater vehicle 16; and an upper portion 36, which is configured to couple to the floating modules 34. The coupling portion 35 comprises at least one mechanical connector (not shown) which is configured to mechanically connect the apparatus 14 to the underwater vehicle 16 (FIGS. 1 and 2); and/or at least one electrical power connector (not shown) which is configured to electrically connect the apparatus 14 to the underwater vehicle 16 (FIGS. 1 and 2) so as to enable the transmission of electrical power from the underwater vehicle 16 (FIGS. 1 and 2) to the apparatus 14; and/or at least one hydraulic power connector (not shown) which is configured to hydraulically connect the apparatus 14 to the underwater vehicle 16 (FIGS. 1 and 2) so as to enable the transmission of hydraulic power from the underwater vehicle 16 (FIGS. 1 and 2) to the apparatus 14; and/or at least one data exchange connector (not shown) which is configured to enable the exchange of data between the underwater vehicle 16 (FIGS. 1 and 2) and the apparatus 14.

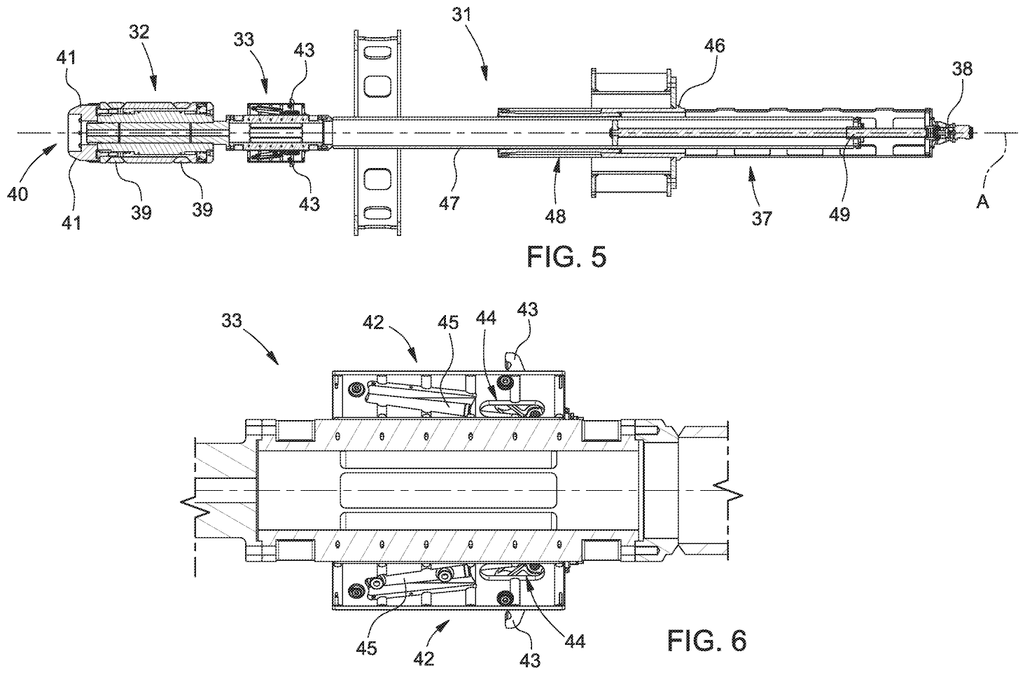

With reference to FIGS. 4 and 5, the apparatus 14 further comprises a handling device 37, which is coupled to the elongated portion 31 of the frame 30, is provided with an actuator 38, such as of the hydraulic type, and is configured to move the alignment device 32 and the locking device 33 in a direction substantially parallel to the longitudinal axis A.

The alignment device 32 comprises at least one expansible element 39, such as made of a polymeric material, which is configured to selectively expand so as to contact an inner surface of the pipe section 4 when the alignment device 32 is inserted within the pipe section 4. In the case described and illustrated herein, the alignment device 32 comprises two expansible elements 39, each of which is configured to expand radially with respect to the longitudinal axis A.

In addition, the apparatus 14 comprises a centering device 40, such as made of polymeric material, which is arranged at one end of the elongated portion 31 of the frame 30 and is shaped so as to facilitate the insertion of the alignment device 32 within the pipe section 4. In particular, the centering device 40 is aligned with the alignment device 32 and the locking device 33 and comprises a plurality of bevelled portions 41.

With reference to FIGS. 4, 5 and 6, the locking device 33 comprises a plurality of movable gripping units 42, which are selectively actuatable to contact a wall of the pipe section 4 to lock the position of the elongated portion 31 of the frame 30 with respect to the pipe section 4.

In particular, each gripping unit 42 comprises a respective tooth 43, which is shaped to interfere with an outer wall of the flange 11 when the respective gripping unit 42 is actuated in the locking position.

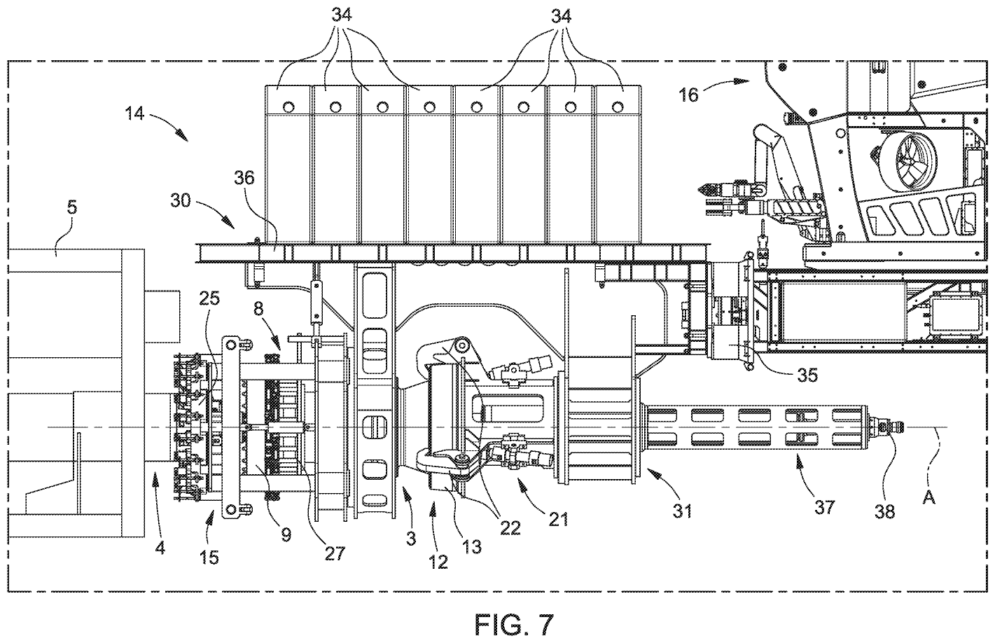

In addition, with reference to FIG. 6, each gripping unit 42 comprises a plurality of actuation mechanisms 44, each of which is provided with an actuator 45 and is configured to selectively extend/retract the respective tooth 43.

With reference to FIG. 5, the elongated portion 31 of the frame 30 comprises a fixed body 46, which supports the handling device 37; and a movable body 47, which is coupled to the fixed body 46 via a telescopic joint 48 so as to slide along the fixed body 46 in a direction substantially parallel to the longitudinal axis A. In the case described and illustrated herein, the handling device 37 comprises a handling mechanism 49 of the screw-nut screw type, which is actuated by the actuator 38 and is configured to enable the sliding of the movable body 47 with respect to the fixed body 46.

In particular, the alignment device 32, the locking device 33 and the centering device 40 are supported by the mobile body 47 and, consequently, in use are moved along the longitudinal axis A based on the handling device 37.

In use and with reference to FIG. 1, the apparatus 14 is coupled to the underwater vehicle 16 and is transported in the body of water 2 by the underwater vehicle 16. The underwater vehicle 16 and the apparatus 14 are controlled and powered by the surface station 17 via the umbilical cable 19.

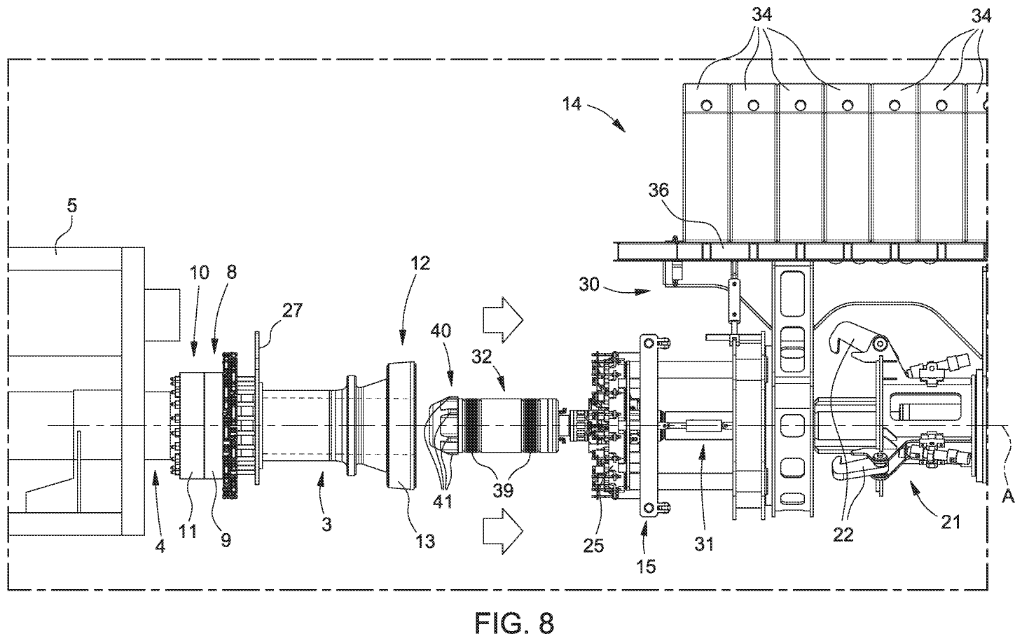

With reference to FIG. 7, the underwater vehicle 16 transports the apparatus 14 near the free end 10 of the pipe section 4 so as to arrange the flange 9 of the pipe section 3 facing the flange 11 of the pipe section 4. At this point, the actuator 38 of the handling device 37 moves the movable body 47 along the longitudinal axis A so as to insert the alignment device 32 inside the pipe section 4. In this circumstance, based on the bevelled portions 41, the centering device 40 facilitates the insertion of the movable body 47 inside the pipe section 4. When the teeth 43 of each gripping unit 42 contact an outer wall of the flange 11, the handling device 37 stops the sliding of the movable body 47 along the fixed body 46 so as to lock the position of the pipe section 3 with respect to the pipe section 4 along the longitudinal axis A.

Subsequently, the expansible elements 39 of the alignment device 32 are expanded radially with respect to the longitudinal axis A so as to contact an inner surface of the pipe section 4, to align the pipe section 3 to the pipe section 4.

The handling device 37 causes the movable body 47 to slide again with respect to the fixed body 46. In this circumstance, since the movable body 47 is locked inside the pipe section 4, the apparatus 14 and the underwater vehicle 16 are moved towards the pipe section 4 along a direction substantially parallel to the longitudinal axis A, so as to approach the pipe section 3 to the pipe section 4.

At this point, the movable arms 25 of the junction device 15 are closed around the pipe section 4 and the actuators 29 of the adjustment mechanism 28 adjust the relative position of the movable arms 25 and the plate 27 with respect to the flanges 9 and 11. Subsequently, the junction device 15 joins the flange 9 and the flange 11 together through the clamping of the bolted junctions 23.

With reference to FIG. 8, once the pipe section 3 and the pipe section 4 are permanently coupled, the movable arms 22 of the retaining device 21 are actuated so as to release the gripping of the flange 13 of the pipe section 3 and the movable arms 25 of the junction device 15 are open.

The gripping units 42 of the locking device 33 and the expansible elements 39 of the alignment device 32 are retracted so as to free the apparatus 14 from the pipe section 3 and the pipe section 4 and the underwater vehicle 16 moves the apparatus 14 away from the pipe section 3 and the pipe section 4.

During the junction operations of the pipe sections 3 and 4, the underwater vehicle 16 electrically and hydraulically powers the apparatus 14 and the junction device 15 and exchanges signals with the apparatus 14 and the junction device 15.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Finally, it is evident that variations can be made to the described embodiment of the present disclosure without departing from the scope of the following claims. That is, the present disclosure also covers embodiments that are not described in the detailed description above as well as equivalent embodiments that are part of the scope of protection set forth in the claims. Accordingly, various changes and modifications to the presently disclosed embodiments will be apparent to those skilled in the art.

1-16. (canceled)

17: An apparatus configured to couple pipe sections in a body of water, the apparatus comprising:
a frame connectable to an unmanned underwater vehicle and comprising an elongated portion extending along a longitudinal axis and configured to be arranged at least partially within a first pipe section to align the first pipe section with respect to the longitudinal axis;
an alignment device supported by the elongated portion of the frame and configured to be at least partially inserted inside a second pipe section to align the first pipe section with the second pipe section; and
a locking device supported by the elongated portion of the frame and configured to lock a position of the first pipe section with respect to the second pipe section when the first pipe section is aligned with the second pipe section.

18: The apparatus of claim 17, further comprising a handling device coupled to the elongated portion of the frame and configured to move the alignment device and the locking device in a direction substantially parallel to the longitudinal axis.

19: The apparatus of claim 18, wherein the handling device comprises an actuator.

20: The apparatus of claim 17, wherein the alignment device and the locking device are aligned along the longitudinal axis.

21: The apparatus of claim 17, wherein the alignment device comprises an expansible element configured to selectively expand to contact an inner surface of the second pipe section when the alignment device is at least partially inserted inside the second pipe section.

22: The apparatus of claim 17, wherein the locking device comprises a plurality of movable gripping units which are selectively actuatable to contact a wall of the second pipe section to lock a position of the elongated portion of the frame with respect to the second pipe section.

23: The apparatus of claim 17, further comprising a centring device arranged at one end of the elongated portion of the frame and shaped to facilitate the at least partial insertion of the alignment device inside the second pipe section.

24: The apparatus of claim 17, further comprising a retaining device carried by the frame and comprises a plurality of movable arms configured to selectively retain the first pipe section.

25: The apparatus of claim 17, further comprising a floating module coupled to the frame.

26: A junction system configured to join pipe sections in a body of water, the junction system comprising:
an apparatus comprising:
a frame connectable to an unmanned underwater vehicle and comprising an elongated portion extending along a longitudinal axis and configured to be arranged at least partially within a first pipe section to align the first pipe section with respect to the longitudinal axis,
an alignment device supported by the elongated portion of the frame and configured to be at least partially inserted inside a second pipe section to align the first pipe section with the second pipe section, and
a locking device supported by the elongated portion of the frame and configured to lock a position of the first pipe section with respect to the second pipe section when the first pipe section is aligned with the second pipe section; and
a junction device carried by the apparatus and configured to join a first flange of the first pipe section to a second flange of the second pipe section that faces the first flange when the first pipe section is aligned and locked with respect to the second pipe section.

27: The junction system of claim 26, wherein the junction device comprises a plurality of bolted junctions configured to extend from opposite bands with respect to the first flange and the second flange and are selectively lockable to clamp the first flange and the second flange together.

28: The junction system of claim 26, further comprising an unmanned underwater vehicle configured to be operatively connected to the apparatus to control a position and an actuation of the apparatus in the body of water.

29: A method for coupling pipe sections in a body of water by an apparatus comprising an alignment device, a locking device and a frame having an elongated portion that extends along a longitudinal axis, the method comprising:
arranging the elongated portion of the frame at least partially within a first pipe section to align the first pipe section with respect to the longitudinal axis;
inserting the alignment device at least partially inside a second pipe section to align the first pipe section with the second pipe section; and
locking, by the locking device, a position of the first pipe section with respect to the second pipe section when the first pipe section is aligned with the second pipe section.

30: The method of claim 29, further comprising expanding an expansible element of the alignment device to cause the expansible element to contact an inner surface of the second pipe section when the alignment device is at least partially inserted inside the second pipe section.

31: The method of claim 29, further comprising actuating a plurality of movable gripping units of the locking device to contact a wall of the second pipe section to lock a position of the elongated portion of the frame with respect to the second pipe section.

32: The method of claim 29, further comprising, when the first pipe section is aligned and locked with respect to the second pipe section, joining a first flange of the first pipe section to a second flange of the second pipe section that faces the first flange.
